(19) United States
(12) Patent Application Publication
(10) Pub. No.: US 2022/0139591 A1
(43) Pub. Date: May 5, 2022

(54) TRANSPARENT CONDUCTIVE FILM, AND TOUCH PANEL INCLUDING SAME

(71) Applicant: SHOWA DENKO K.K., Tokyo (JP)

(72) Inventors: Shigeru YAMAKI, Minato-ku, Tokyo (JP); Shuhei YONEDA, Tokyo (JP); Masahiko TOBA, Minato-ku, Tokyo (JP)

(73) Assignee: SHOWA DENKO K.K., Tokyo (JP)

(21) Appl. No.: 17/431,496

(22) PCT Filed: Feb. 17, 2020
(86) PCT No.: PCT/JP2020/006098

§ 371 Date: Aug. 17, 2021

(30) Foreign Application Priority Data
Feb. 18, 2019 (JP) 2019-026552

(51) Int. Cl. H01B 1/22; G06F 3/044; H01B 5/14; C08J 7/04; C08K 7/06; C08K 3/08; C08J 7/044

(52) U.S. Cl. CPC H01B 1/22; G06F 3/044; H01B 5/14; C08J 7/042; C08K 7/06; C08K 3/08; C08J 2365/00; C08K 2201/001; C08K 2201/011; C08K 2003/0806; C08J 2475/06; C08J 2439/06; C08J 7/044

(57) ABSTRACT

Provided is a transparent conductive film having a preferable optical property and an electric property, and in addition, a superior durability of folding. A transparent conductive film comprising: a transparent substrate, a transparent conductive layer having a binder resin and conductive fibers and formed on at least one of the main faces of the transparent substrate, and a protective layer formed on the transparent conductive layer, wherein the protective layer is a cured layer of a curable resin composite and has a thickness of more than 100 nm and 1 μm or less.

### TECHNICAL FIELD

The present disclosure relates to a transparent conductive film and a touch panel including the same.

### BACKGROUND ART

A transparent conductive film is used in various fields such as a transparent electrode for a liquid crystal display (LCD), a plasma display panel (PDP), an organic electroluminescence type display, photovoltaics (PV), and a touch panel (TP), an electrostatic discharge (ESD) film, and an electromagnetic interference (EMI) film, etc. For these transparent conductive films, conventionally, a film using ITO (Indium Tin Oxide) has been used.

Recently, touch panels are applied in smartphones, car navigation systems, vending machines, and the like. In particular, a foldable smartphone receives attention, and thus, a bendable touch panel has been desired.

In order to obtain a foldable touch panel, a foldable transparent conductive film, namely, a transparent conductive film having a superior durability of folding is necessary. In view of the application to a foldable smartphone, it is preferable that the curvature radius of the transparent conductive film at the time of folding is as small as possible, and the change in performance (resistance) when the folding is repeated is also as small as possible.

However, ITO used for the conventional transparent conductive film for a touch panel, is a metal oxide, and thus, there are problem that when the film is fold, the film is broken, resulting in remarkably deteriorating the conductivity. In order to solve the problem, a metal nanowire film has been developed as a transparent conductive film of the next generation.

Patent Document 1 discloses a silver nanowire film capable of maintaining conductivity after the mandrel bending test where the film is bent to become a cylindrical shape. However, the film has a large curvature radius of 5 mm, and evaluation is performed only for approximately 20 repeats.

Each of Patent Documents 2 and 3 discloses a silver nanowire cyclo-olefin polymer (COP) film having a superior durability of folding. Patent Document 2 fails to disclose results of actual folding test. Patent Document 3 only discloses wrapping of the film around a cylinder having a curvature radius of 3 mm, the curvature radius being large, but fails to disclose repeat resistance to the bend.

The applicant of the present application previously discloses, in Patent Document 4, a transparent conductive substrate comprising a transparent substrate, a transparent conductive film having a binder resin and conductive fibers (metal nanowires) and formed at least on one main face of the transparent substrate, and a protective film formed on the transparent conductive film. However, Patent Document 4 is not suggested of regarding the durability of folding, and fails to disclose nor suggest a preferable structure for obtaining the durability of folding.

### PRIOR ARTS

### Patent Documents

Patent Document 1: Japanese Unexamined Patent Publication (Kokai) No. 2013-225460
Patent Document 2: Japanese Unexamined Patent Publication (Kokai) No. 2016-110995
Patent Document 3: Japanese Unexamined Patent Publication (Kokai) No. 2015-114919
Patent Document 4: WO 2018/101334 pamphlet

### SUMMARY

One of the objectives of the present disclosure is to provide a transparent conductive film having a preferable optical property, a preferable electric property, and further having a superior durability of folding, and a touch panel including the same.

The present disclosure has the following aspects.

[1] A transparent conductive film comprising: a transparent substrate, a transparent conductive layer having a binder resin and conductive fibers and formed on at least one of the main faces of the transparent substrate, and a protective layer formed on the transparent conductive layer, wherein the protective layer is a cured layer of a curable resin composite and has a thickness of more than 100 nm and 1 μm or less.

[2] A transparent conductive film according to [1], wherein the conductive fiber is a metal nanowire.

[3] A transparent conductive film according to [2], wherein the metal nanowire is a silver nanowire.

[4] A transparent conductive film according to any one of [1] to [3], wherein the protective layer is a thermally cured layer of a curable resin composite containing (A) polyurethane containing a carboxy group, (B) an epoxy compound, and (C) a curing accelerator.

[5] A transparent conductive film according to any one of [1] to [4], wherein the binder resin is soluble in alcohol, water, or a mixed solvent of alcohol and water.

[6] A transparent conductive film according to [5], wherein the binder resin contains poly-N-vinylpyrrolidone, water-soluble cellulose-based resin, butyral resin, or poly-N-vinylacetamide.

[7] A transparent conductive film according to any one of [1] to [6], wherein the transparent substrate is a cyclo-olefin polymer (COP) film.

[8] A transparent conductive film according to [7], wherein the COP film has a thickness of 5 to 20 μm.

[9] A transparent conductive film according to [7] or [8], wherein the COP film has a glass transition temperature (Tg) is 90 to 170° C.

[10] A transparent conductive film according to [7] or [8], wherein the COP film has a glass transition temperature (Tg) of 125 to 145° C.

[11] A transparent conductive film according to any one of [1] to [10], wherein the protective layer has a thickness of more than 100 nm and 200 nm or less.

[12] A transparent conductive film according to any one of [1] to [10], wherein the protective layer has a thickness of more than 100 nm and 120 nm or less.

[13] A transparent conductive film according to any one of [1] to [12], wherein a content of an aromatic ring-containing compound in the solid of the curable resin composite for forming the protective layer is 15% by mass or less.

[14] A transparent conductive film according to any one of [1] to [13], wherein, when a resistance value (R₀) and a resistance value (R) respectively represents resistance values of the transparent conductive film before and after 200,000 times of folding tests using a clamshell type durability tester in which the curvature radius is set to 1 mm, the ratio (R/R₀) is 2.0 or less.

[15] A touch panel including a transparent conductive film according to any one of [1] to [14].

According to the present disclosure, a transparent conductive film having a preferable optical property, a preferable electric property, and further having a superior durability of folding, and a touch panel including the same, can be provided.

### BRIEF DESCRIPTION OF DRAWINGS

FIG. 1 shows a structure of an out-cell electrostatic capacitance type touch panel according to an example of the present disclosure.

### ASPECT OF DISCLOSURE

Hereinbelow, aspects of the present disclosure (hereinbelow, referred to as aspects) will be explained.

A transparent conductive film according to the present aspect comprising a transparent substrate, a transparent conductive layer having a binder resin and conductive fibers and formed on at least one of the main faces of the transparent substrate, and a protective layer formed on the transparent conductive layer, and has features that the protective layer is a cured layer of a curable resin composite and has a thickness of more than 100 nm and 1 μm or less. In the present specification, “transparent” refers to a total light transmittance of 75% or more.

### <Transparent Substrate>

The transparent substrate may be colored, but preferably has a high total light transmittance (transparency to visible light), the total light transmittance being preferably 80% or higher. For example, a resin film such as polyester (polyethylene terephthalate [PET], polyethylene naphthalate [PEN], etc.), polycarbonate, acrylic resin (polymethyl methacrylate [PMMA], etc.), cyclo-olefin polymer, and the like, may be preferably used. Further, as far as the optical property, electrical property, and durability of folding are not damaged, a layer or a plurality of layers having a function of easy adhesion, optical adjustment (antiglare, antireflection, etc.), hard coating, etc., may be provided on one face or both faces of the transparent substrate Among these resin films, in view of the superior light transmittance (transparency), flexibility, mechanical property, etc., using polyethylene terephthalate, cyclo-olefin polymer is preferable. Examples of the cyclo-olefin polymer include: hydrogenated ring-opening metathesis polymerization type cyclo-olefin polymer of norbornene (ZEONOR (registered trademark, manufactured by Zeon Corporation), ZEONEX (registered trademark, manufactured by Zeon Corporation), ARTON (registered trademark, manufactured by JSR Corporation), etc.), norbornene/ethylene addition copolymer type cyclo-olefin polymer (APEL (registered trademark, manufactured by Mitsui Chemicals Inc.), TOPAS (registered trademark, manufactured by Polyplastics Co., Ltd.)). Regarding the above, in order to be resistant against heating in the subsequent steps of forming lead wiring, connecting part etc., a glass transition temperature (Tg) is preferably 90 to 170° C., more preferably 125 to 145° C., and a thickness is preferably 1 to 20 μm, more preferably 5 to 20 μm, and still more preferably 8 to 20 μm.

### <Transparent Conductive Layer>

The conductive fiber structuring the transparent conductive layer may be metal nanowire, carbon fiber, etc., and using the metal nanowire is preferable. The metal nanowire is an conductive material made of metal and having a wire shape with a diameter in the order of nanometer. In the present aspect, in addition to (by mixing with) or instead of the metal nanowire, metal nanotube which is a conductive material having a porous or nonporous tubular shape, may be used. In the present specification, both the “wire shape” and the “tubular shape” refer to a linear shape, but the former refers to a solid body, while the latter refers to a hollow body. Both may be soft or rigid. The former is referred to as “metal nanowire in a narrow sense”, and the latter is referred to a “metal nanotube in a narrow sense”. Hereinbelow, in the present specification, the term “metal nanowire” is used to include both the metal nanowire in a narrow sense and the metal nanotube in a narrow sense. Only the metal nanowire in a narrow sense, or only the metal nanotube in a narrow sense may be used, or they may be mixed for use.

As a method for producing the metal nanowire, a known method may be applied. For example, silver nanowires may be synthesized by reducing the silver nitrate under the presence of polyvinylpyrrolidone, using a polyol method (refer to Chem. Mater., 2002, 14, 4736). Similarly, gold nanowires may be synthesized by reducing the gold chloride acid hydrate under the presence of polyvinylpyrrolidone (refer to J. Am. Chem. Soc., 2007, 129, 1733). WO 2008/073143 pamphlet and WO 2008/046058 pamphlet have detailed description regarding the technology of large scale synthesis and purification of silver nanowires and gold nanowires. Gold nanotubes having a porous structure may be synthesized by using silver nanowires as templates, and reducing a gold chloride acid solution. The silver nanowires used as templates are dissolved in the solution by oxidation-reduction reaction with the gold chloride acid, and as a result, gold nanotubes having a porous structure can be produced (refer to J. Am. Chem. Soc., 2004, 126, 3892-3901).

The metal nanowires have an average diameter size of preferably 1 to 500 nm, more preferably 5 to 200 nm, still more preferably 5 to 100 nm, and particularly preferably 10 to 50 nm. The metal nanowires have an average major axis length of preferably 1 to 100 μm, more preferably 1 to 80 μm, still more preferably 2 to 70 μm, and particularly preferably 5 to 50 μm. While satisfying the above average diameter size and the average major axis length, the metal nanowires have an average aspect ratio of preferably more than 5, more preferably 10 or more, still more preferably 100 or more, and particularly preferably 200 or more. Here, the aspect ratio refers to a value obtained by a/b, wherein “b” represents an average diameter size of the metal nanowire and the metal nanotube and “a” represents an average major axis length thereof. The values “a” and “b” may be measured by a scanning electron microscope (SEM) and an optical microscope. Specifically, diameters of arbitrarily selected 100 silver nanowires are respectively measured by using Field Emission Scanning Electron Microscope JSM-7000F (manufactured by JEOL Ltd.), and an arithmetic average value was calculated as b (average diameter). Also, lengths of arbitrarily selected 100 silver nanowires are respectively measured by using 3D Laser Scanning Microscope VK-X200 (manufactured by Keyence Corporation), and an arithmetic average value was calculated as the average value a (average length).

Materials for the metal nanowires may be one selected from the group consisting of gold, silver, platinum, copper, nickel, iron, cobalt, zinc, ruthenium, rhodium, palladium, cadmium, osmium, and iridium, or may be an alloy etc., formed by combining some of these. In order to obtain a coating film having a low surface resistance and a high total light transmittance, containing at least one of gold, silver, and copper is preferable. These metals have a high electroconductivity, and thus, when a certain surface resistance should be obtained, the density of the metal within the surface may be reduced, and high total light transmittance can be achieved. Among these metals, containing at least gold or silver is preferable. The most appropriate example may be the silver nanowire.

The transparent conductive layer includes an conductive fiber and a binder resin. As for the binder resin, anything can be used as far as the objectives of the present disclosure can be satisfied, i.e., the durability of folding and the transparency are sufficient. However, when metal nanowires produced by the polyol method are used for the conductive fiber, in view of the compatibility with the solvent of production (polyol), a binder resin soluble in alcohol, water, or a mixed solvent of alcohol and water is preferably used. Specific examples include: poly-N-vinylpyrrolidone, a water-soluble cellulose-based resin such as methyl cellulose, hydroxyethyl cellulose, and carboxymethyl cellulose, a butyral resin, and poly-N-vinylacetamide (PNVA (registered trademark)).

Poly-N-vinylacetamide is a homopolymer of N-vinylacetamide (NVA), but a copolymer having 70 mol % or more of N-vinylacetamide (NVA) may also be used. Examples of a monomer which can be copolymerized with NVA include: N-vinylformamide, N-vinylpyrrolidone, acrylic acid, methacrylic acid, sodium acrylate, sodium methacrylate, acrylamide, acrylonitrile, and the like. The more the content of the copolymerized component, the higher the sheet resistance of the transparent conductive layer to be obtained, the lower the adhesion between the silver nanowires and the substrate, and the lower the heat resistance (thermal decomposition starting temperature). Therefore, the polymer contains the monomer unit derived from N-vinylacetamide preferably 70 mol % or more, more preferably 80 mol % or more, and still more preferably 90 mol % or more. Such a polymer has an absolute molecular weight of preferably 30,000 to 4,000,000, more preferably 100,000 to 3,000,000, and still more preferably 300,000 to 1,500,000. The absolute molecular weights were measured by the following method.

### <Measurement Of Absolute Molecular Weight>

A binder resin was dissolved in the following eluent, and was left to stand for 20 hours. In the solution, the concentration of the binder resin is 0.05% by mass.

The solution was filtered by a 0.45 μm membrane filter, and a molecular weight of the filtrate was measured by GPC-MALS.

GPC: Shodex (Registered Trademark) SYSTEM21, manufactured by Showa Denko K.K.
Column: TSKgel (Registered Trademark) G6000PW manufactured by Tosoh Corporation

### Column Temperature:40° C.

Eluent: 0.1 mol/L NaH₂PO₄ aqueous solution+0.1 mol/L Na₂HPO₄ aqueous solution
Flow Rate: 0.64 mL/min

### Sample Injection Amount: 100 μL

MALS Detector: Wyatt Technology Corporation, DAWN (registered trademark) DSP

### Laser Wavelength: 633 nm

### Multiangle Fitting Method: Berry Method

One of the above resins may be used solely, but two or more types of the resins may be used in combination. When two or more types of resins are used in combination, the combination may be a simple mixing, or may be a copolymer.

The transparent conductive layer can be formed by printing an conductive ink containing the conductive fiber, the binder resin, and a solvent, on at least one of the main faces of the transparent substrate, and removing the solvent by drying.

The solvent is not limited as far as the conductive fibers can be preferably dispersed therein, and the binder resin can be dissolved therein. However, when metal nanowires synthesized by the polyol method are used as conductive fibers, taking into account the compatibility with the solvent of production(polyol), alcohol, water, or a mixed solvent of alcohol and water are preferable. As mentioned above, a preferable binder resin is also the one soluble in alcohol, water, or a mixed solvent of alcohol and water, from the viewpoint of easily controlling the drying speed of the binder resin, using a mixed solvent of alcohol and water is more preferable. The alcohol includes at least one type of saturated monohydric alcohols having 1 to 3 carbon atoms (methanol, ethanol, n-propanol, isopropanol), which are represented by CₙH₂ₙ₊₁OH (n being an integer of 1 to 3) [hereinbelow, merely described as “saturated monohydric alcohol having 1 to 3 carbon atoms” ]. The saturated monohydric alcohol having 1 to 3 carbon atoms is contained preferably 40% by mass or more in the alcohol in total. Using the saturated monohydric alcohol having 1 to 3 carbon atoms is advantageous because drying process becomes easy. Alcohols other than the saturated monohydric alcohol having 1 to 3 carbon atoms can be used together. Examples of other alcohols which can be used together with the saturated monohydric alcohol having 1 to 3 carbon atoms include ethylene glycol, propylene glycol, ethylene glycol monomethylether, ethylene glycol monoethylether, propylene glycol monomethylether, propylene glycol monoethylether, and the like. Using such alcohol together with the saturated monohydric alcohol having 1 to 3 carbon atoms is advantageous because the drying speed can be adjusted. The content of the total alcohol in the mixed solvent is preferably 5% to 90% by mass. If the alcohol content in the mixed solvent is less than 5% by mass or more than 90% by mass, there are drawbacks such that a strip pattern (uneven coating) is generated at the time of coating.

The conductive ink can be produced by stirring and mixing the binder resin, the conductive fibers, and the solvent, using a planetary centrifugal mixer. The content of the binder resin in the conductive ink is preferably in the range of 0.01% to 1.0% by mass. The content of the conductive fiber contained in the conductive ink is preferably in the range of 0.01% to 1.0% by mass. The content of the solvent in the conductive ink is preferably in the range of 98.0% to 99.98% by mass.

The conductive ink may be printed by a bar-coating method, spin-coating method, spray coating method, gravure printing, slit coating, and the like. The shape of a printed film or pattern formed thereby is not particularly limited, but may be a shape of wiring or electrode pattern formed on the substrate, a shape of a film covering the entirety or a part of the substrate (solid paint pattern), or the like. The formed pattern can be made conductive by heating and drying the solvent. The preferable thickness of transparent conductive layer or the transparent conductive pattern obtained after the solvent is dried may be different depending on the diameter of the conductive fiber used, or a desired surface resistance value, but the thickness is preferably 10 to 300 nm, and more preferably 30 to 200 nm. If the thickness is larger than 10 nm, the number of intersections of the conductive fibers increases, resulting in showing preferable electroconductivity.

If the thickness is smaller than 300 nm, more light can be transmitted and reflection by the conductive fiber is suppressed, and thus, a preferable optical property can be obtained. The formed conductive pattern can be made conductive by heating and drying the solvent. However, in accordance with needs, an appropriate photoirradiation may be applied to the conductive pattern.

### <Protective Layer>

The protective layer which protects the transparent conductive layer is a cured layer of a curable resin composite. The curable resin composite preferably contains (A) a polyurethane containing a carboxy group, (B) an epoxy compound, (C) a curing accelerator, and (D) a solvent. The curable resin composite is formed on the transparent conductive layer by printing, coating, etc., and is cured to form a protective layer. Curing of the curable resin composite can be performed, when a thermosetting resin composite is used, by heating and drying the thermosetting resin composite.

When a photocurable resin composite is used as the curable resin composite, curing is performed by absorbing light, and thus, a light absorbing component remains in a cured film. Therefore, such a photocurable resin composite can be preferably used within a range that the total light transmittance and the durability of folding are well-balanced.

The (A) polyurethane containing a carboxy group has a weight average molecular weight of preferably 1,000 to 100,000, more preferably 2,000 to 70,000, and still more preferably 3,000 to 50,000. Here, the molecular weight is a polystyrene equivalent value measured by gel permeation chromatography (hereinbelow, referred to as GPC). If the molecular weight is less than 1,000, the elongation property, the flexibility, and the strength of the coated layer after printing may be decreased. Whereas, if the molecular weight exceeds 100,000, the solubility of polyurethane to the solvent is decreased, and even when polyurethane can dissolve in the solvent, the viscosity becomes too high, which may cause great limitations in use.

In the present specification, the measurement conditions of GPC are as follows, unless specifically described:

Device Name: HPLC unit HSS-2000, manufactured by JASCO Corporation

### Column: Shodex Column LF-804

Eluent: tetrahydrofuran
Flow Rate: 1.0 mL/min
Detector: RI-2031 Plus manufactured by JASCO Corporation

### Temperature: 40.0° C.

Sample Volume: sample loop 100 μL
Sample Concentration: Prepared to approximately 0.1% by mass

The (A) polyurethane containing a carboxy group has an acid value of preferably 10 to 140 mg-KOH/g, and more preferably 15 to 130 mg-KOH/g. If the acid value is less than 10 mg-KOH/g, the curing property is decreased, and the solvent resistance becomes worse. Whereas, if the acid value exceeds 140 mg-KOH/g, the solubility to the solvent as a urethane resin decreases, and even when the urethane resin can dissolve in the solvent, the viscosity becomes too high, which makes the handling difficult. In addition, the cured product becomes too hard, which may cause problems such as warpage, etc., in some substrate films.

Further, in the present specification, the acid value of a resin is a value measured by the following method.

Approximately 0.2 g of sample is precisely weighed by a precision balance into a 100 ml Erlenmeyer flask, and 10 ml of a mixture solvent of ethanol/toluene=1/2 (mass ratio) is provided thereto to dissolve the sample. Further, 1 to 3 drops of a phenolphthalein ethanol solution are added to the container as an indicator, which is sufficiently stirred until the sample becomes uniform. The resultant is subjected to titration with a 0.1 N potassium hydroxide-ethanol solution. When the indicator continues to be in light red for 30 seconds, it is determined that the neutralization ends. The value obtained from the result using the following calculation formula is treated as an acid value of the resin.

Acid Value (mg-KOH/g)=[B×f×5.611]/S
B: Use amount (ml) of 0.1 N potassium hydroxide-ethanol solution
f: Factor of 0.1 N potassium hydroxide-ethanol solution
S: Quantity (g) of sample

More specifically, the (A)polyurethane containing a carboxy group is polyurethane synthesized by using (a1) a polyisocyanate compound, (a2) a polyol compound, and (a3) a dihydroxy compound containing a carboxy group, as monomers. From the viewpoint of light resistance and weather resistance, preferably, each of (a1), (a2), and (a3) does not contain a functional group with conjugate properties such as an aromatic compound. Hereinbelow, each monomer will be explained in more detail.

### (a1) Polyisocyanate Compound

For (a1) polyisocyanate compound, usually, diisocyanate which has two isocyanato groups per molecule is used. Examples of the polyisocyanate compound include: aliphatic polyisocyanate, alicyclic polyisocyanate, and the like. One of them may be used by itself, or two or more of them may be used in combination. As far as (A) polyurethane containing a carboxy group is not turned into a gel, a small amount of polyisocyanate having three or more isocyanato groups may also be used.

Examples of the aliphatic polyisocyanate include: 1,3-trimethylene diisocyanate, 1,4-tetramethylene diisocyanate, 1,6-hexamethylene diisocyanate, 1,9-nonamethylene diisocyanate, 1,10-decamethylene diisocyanate, 2,2,4-trimethylhexamethylene diisocyanate, 2,4,4-trimethylhexamethylene diisocyanate, lysine diisocyanate, 2,2′-diethyl ether diisocyanate, dimer acid diisocyanate, and the like.

Examples of the alicyclic polyisocyanate include: 1,4-cyclohexane diisocyanate, 1,3-bis(isocyanatomethyl)cyclohexane, 1,4-bis(isocyanatomethyl)cyclohexane, 3-isocyanatomethyl-3,5,5-trimethylcyclohexyl isocyanate (IPDI, isophorone diisocyanate), bis(4-isocyanato cyclohexyl)methane (Hydrogenated MDI), hydrogenated (1,3- or 1,4-)xylylene diisocyanate, norbornane diisocyanate, and the like.

Here, if an alicyclic compound having 6 to 30 carbon atoms other than the carbon atoms in the isocyanato group (—NCO group) is used as (a1) polyisocyanate compound, a protective layer formed by the polyurethane resin according to the present aspect has high reliability particularly under high temperature and high humidity, and is suitable as a member for an electronic device component. Among the exemplified alicyclic compounds, 1,4-cyclohexane diisocyanate, isophorone diisocyanate, bis(4-isocyanato cyclohexyl) methane, 1,3-bis(isocyanatomethyl) cyclohexane, 1,4-bis(isocyanatomethyl) cyclohexane, are preferable.

From the viewpoints of weather resistance and light resistance, as for (a1) polyisocyanate compound, using a compound which does not have an aromatic ring is preferable. When the aromatic polyisocyanate or the aromatic-aliphatic polyisocyanate is used, in accordance with needs, the content thereof is preferably 50 mol % or less, more preferably 30 mol % or less, and still more preferably 10 mol % or less, relative to the total amount (100 mol %) of (a1) polyisocyanate compound.

### (a2) Polyol Compound

The number average molecular weight of (a2) polyol compound (with the proviso that (a2) polyol compound does not include (a3) dihydroxy compound having a carboxy group) is usually 250 to 50,000, preferably 400 to 10,000, and more preferably 500 to 5,000. The molecular weight is a polystyrene equivalent value measured by the GPC under the above mentioned conditions.

Examples of (a2) polyol compound include: polycarbonate polyol, polyether polyol, polyester polyol, polylactone polyol, polysilicone having hydroxy groups at both ends, and a polyol compound having 18 to 72 carbon atoms obtained by adding hydrogen to a polycarboxilic acid derived from a C18 (carbon atom number 18) unsaturated fatty acid made from vegetable oil and a polymer thereof, and converting the carboxylic acid into hydroxy groups. Among them, in view of the balance of the water resistance, the insulation reliability, and the adhesion to a substrate material, polycarbonate polyol is preferable.

The polycarbonate polyol can be obtained from diol having 3 to 18 carbon atoms as a raw material, through reaction with carbonate ester or phosgene, and can be represented by, for example, the following structural formula (1):

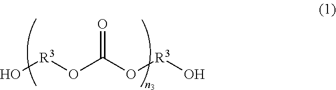

In Formula (1), R³ represents a residue after removing a hydroxy group from a corresponding diol (HO—R³—OH), i.e., an alkylene group having 3 to 18 carbon atoms, and n₃ represents a positive integer, which is preferably 2 to 50.

Specific examples of the raw material used for producing the polycarbonate polyol represented by Formula (1) include: 1,3-propanediol, 1,4-butanediol, 1,5-pentanediol, 1,6-hexanediol, 3-methyl-1,5-pentanediol, 1,8-octanediol, 1,3-cyclohexanedimethanol, 1,4-cyclohexanedimethanol, 1,9-nonanediol, 2-methyl-1,8-octanediol, 1,10-decamethylene glycol, and 1,2-tetradecanediol, etc.

The polycarbonate polyol may be a polycarbonate polyol (copolymerized polycarbonate polyol) having a plurality of types of alkylene groups in its skeleton. Using a copolymerized polycarbonate polyol is advantageous in many cases from the viewpoint of preventing crystallization of (A) polyurethane containing a carboxy group. Further, taking the solubility to the solvent into account, using, in combination, a polycarbonate polyol having a branched skeleton and having hydroxy groups at the ends of the branched chains, is preferable.

The polyether polyol is obtained by the dehydration condensation of a diol having 2 to 12 carbon atoms, or the ring-opening polymerization of an oxirane compound, oxetane compound, or tetrahydrofuran compound having 2 to 12 carbon atoms, and may be represented by, for example, the following structural formula (2):

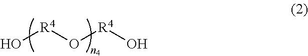

In Formula (2), R⁴ represents a residue obtained by removing a hydroxy group from a corresponding diol (HO—R⁴—OH), i.e., an alkylene group having 2 to 12 carbon atoms, n₄ represents a positive integer, which is preferably 4 to 50. One type of the diol having 2 to 12 carbon atoms may be used by itself to form a homopolymer, or two or more types may be used in combination to form a copolymer.

Specific examples of the polyether polyol represented by the above Formula (2) include: polyalkylene glycols such as polyethylene glycol, polypropylene glycol, poly-1,2-butylene glycol, polytetramethylene glycol (poly 1,4-butanediol), poly-3-methyltetramethylene glycol, polyneopentyl glycol, and the like. Further, in order to increase the hydrophobic property of the polyether polyol, a copolymer of these, for example, a copolymer of 1,4-butanediol and neopentyl glycol, etc., may be used.

The polyester polyol may be obtained by dehydration condensation of a dicarboxylic acid and a diol, or a transesterification of diol with an ester of a dicarboxylic acid and a lower alcohol, and may be represented by, for example, the following structural formula (3)

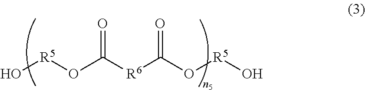

In Formula (3), R⁵ represents a residue obtained by removing a hydroxy group from the corresponding diol (HO—R⁵—OH), i.e., an alkylene group or an organic group having 2 to 10 carbon atoms, R⁶ represents a residue obtained by removing two carboxy groups from the corresponding dicarboxylic acid (HOCO—R⁶—COOH), i.e., an alkylene group or an organic group having 2 to 12 carbon atoms, n₅ represents a positive integer, which is preferably 2 to 50.

Specific examples of the diol (HO—R⁵—OH) include: ethylene glycol, 1,2-propanediol, 1,3-propanediol, 1,2-butanediol, 1,3-butanediol, 1,4-butanediol, 1,5-pentanediol, 1,6-hexanediol, 3-methyl-1,5-pentanediol, 1,8-octanediol, 1,3-cyclohexanedimethanol, 1,4-cyclohexanedimethanol, 1,9-nonanediol, 2-methyl-1,8-octanediol, 1,10-decamethylene glycol, 1,2-tetradecanediol, 2,4-diethyl-1,5-pentanediol, butyl ethyl propanediol, 1,3-cyclohexanedimethanol, diethylene glycol, triethylene glycol, dipropylene glycol, and the like.

Specific examples of the dicarboxylic acid (HOCO—R⁶—COOH) include: succinic acid, glutaric acid, adipic acid, azelaic acid, sebacic acid, decane dicarboxylic acid, brasylic acid, 1,4-cyclohexane dicarboxylic acid, hexahydrophthalic acid, methyl tetrahydrophthalic acid, endomethylene tetrahydrophthalic acid, methyl endomethylene tetrahydrophthalic acid, chlorendic acid, fumaric acid, maleic acid, itaconic acid, citraconic acid.

The polylactone polyol may be obtained by the condensation reaction of a ring-opening polymerized lactone and a diol, or the condensation reaction of a diol and a hydroxy alkanoic acid, and may be represented by, for example, the following structural formula (4):

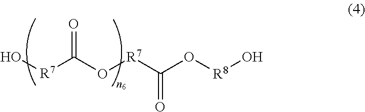

In Formula (4), R⁷ represents a residue obtained by removing a hydroxy group and a carboxy group from a corresponding hydroxy alkanoic acid (HO—R⁷—COOH), i.e., an alkylene group having 4 to 8 carbon atoms, R⁸ represents a residue obtained by removing a hydroxy group from a corresponding diol (HO—R⁸—OH), i.e., an alkylene group having 2 to 10 carbon atoms, n₆ is a positive integer, which is preferably 2 to 50.

Specific examples of the hydroxy alkanoic acid (HO—R⁷—COOH) include: 3-hydroxybutanoic acid, 4-hydroxypentanoic acid, 5-hydroxyhexanoic acid, and the like. Examples of lactone include ε-caprolactone.

The polysilicone having hydroxy groups at both ends may be represented by, for example, the following structural formula (5):

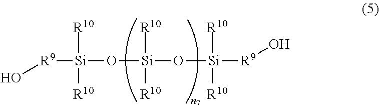

In Formula (5), R⁹ independently represents a divalent aliphatic hydrocarbon residue having 2 to 50 carbon atoms, n₇ is a positive integer, which is preferably 2 to 50. R⁹ may include an ether group. Each of a plurality of R¹⁰ independently represents an aliphatic hydrocarbon group having 1 to 12 carbon atoms. Market products of the polysilicone having hydroxy groups at both ends include, for example, “X-22-160AS, KF6001, KF6002, KF-6003” manufactured by Shin-Etsu Chemical Co., Ltd., and the like.

Specific examples of the “polyol compound having 18 to 72 carbon atoms obtained by adding hydrogen to a polycarboxilic acid derived from a C18 unsaturated fatty acid made from vegetable oil and a polymer thereof, and converting the carboxylic acid into hydroxy groups” include a diol compound having a skeleton of a hydrogenated dimer acid, and a marketed product thereof is, for example, “Sovermol (registered trademark) 908” manufactured by Cognis.

As far as the effect of the present disclosure is not ruined, a diol having a molecular weight of 300 or less, which is usually used as a diol component for synthesizing polyester or polycarbonate may be used as (a2) polyol compound. Specific examples of such a low molecular weight diol include: ethylene glycol, 1,2-propanediol, 1,3-propanediol, 1,2-butanediol, 1,3-butanediol, 1,4-butanediol, 1,5-pentanediol, 1,6-hexanediol, 3-methyl-1,5-pentanediol, 1,8-octanediol, 1,3-cyclohexanedimethanol, 1,4-cyclohexanedimethanol, 1,9-nonanediol, 2-methyl-1,8-octanediol, 1,10-decamethylene glycol, 1,2-tetradecanediol, 2,4-diethyl-1,5-pentanediol, butyl ethyl propanediol, 1,3-cyclohexanedimethanol, diethylene glycol, triethylene glycol, and dipropylene glycol, and the like.

(a3) Dihydroxy Compound Containing Carboxy Group Preferably, (a3) a dihydroxy compound containing a carboxy group is a carboxylic acid or an amino carboxylic acid having a molecular weight of 200 or less, having two groups selected from a hydroxy group, a hydroxyalkyl group with one carbon, and a hydroxyalkyl group with 2 carbons, because a cross linking point is controllable. Specific examples include: 2,2-dimethylolpropionic acid, 2,2-dimethylolbutanoic acid, N,N-bis hydroxyethyl glycine, N,N-bis hydroxyethyl alanine, and the like. Among them, in view of the solubility to the solvent, 2,2-dimethylolpropionic acid, 2,2-dimethylolbutanoic acid are particularly preferable. One type of the compounds of (a3) dihydroxy compound containing a carboxy group can be used by itself, or two or more types may be used in combination.

The above-mentioned (A) a polyurethane containing a carboxy group can be synthesized from the above three components ((a1), (a2), and (a3)) only. However, (a4) a monohydroxy compound and/or (a5) a monoisocyanate compound may be further reacted for synthesis. In view of the light resistance, using a compound which does not have an aromatic ring and a carbon-carbon double bond in a molecule is preferable.

### (a4) Monohydroxy Compound

An example of (a4) monohydroxy compound is a compound having a carboxy group such as a glycolic acid, a hydroxypivalic acid, etc.

One type of (a4) monohydroxy compound can be used by itself, or two or more types of (a4) can be used in combination.

Other examples of (a4) monohydroxy compound include:

methanol, ethanol, n-propanol, isopropanol, n-butanol, isobutanol, sec-butanol, t-butanol, amyl alcohol, hexyl alcohol, octyl alcohol, and the like.

### (a5) Monoisocyanate Compound

Examples of (a5) monoisocyanate compound include: hexyl isocyanate, dodecyl isocyanate, and the like.

The above-mentioned (A) polyurethane containing a carboxy group can be synthesized by reacting the above-mentioned (a1) polyisocyanate compound, (a2) polyol compound, and (a3) dihydroxy compound containing a carboxy group, under the presence or absence of a known urethanization catalyst such as dibutyltin dilaurate, using an appropriate organic solvent. However, performing reaction without a catalyst is preferable because there would be no need to concern about the mixing of tin, etc., in the final product.

The organic solvent is not particularly limited as far as the reactivity with the isocyanate compound is low, but a preferable solvent is a solvent free from a basic functional group such as amine, etc., and having a boiling point of 50° C. or higher, preferably 80° C. or higher, and more preferably 100° C. or higher. Examples of such a solvent include: toluene, xylylene, ethylbenzene, nitrobenzene, cyclohexane, isophorone, diethylene glycol dimethyl ether, ethylene glycol diethyl ether, ethylene glycol monomethyl ether acetate, propylene glycol monomethyl ether acetate, propylene glycol monoethyl ether acetate, dipropylene glycol monomethyl ether acetate, diethylene glycol monoethyl ether acetate, methoxypropionic acid methyl, methoxypropionic acid ethyl, ethoxypropionic acid methyl, ethoxypropionic acid ethyl, ethyl acetate, n-butyl acetate, isoamyl acetate, ethyl lactate, acetone, methyl ethyl ketone, cyclohexanone, N,N-dimethylformamide, N,N-dimethylacetamide, N-methylpyrrolidone, γ-butyrolactone, dimethyl sulfoxide, and the like.

Taking into account that it is not preferable to use an organic solvent in which the polyurethane to be generated does not dissolve well, and that the polyurethane is used as a raw material for the protective film ink used for an electronic material, propylene glycol monomethyl ether acetate, propylene glycol monoethyl ether acetate, dipropylene glycol monomethyl ether acetate, diethylene glycol monoethyl ether acetate, γ-butyrolactone, etc., are particularly preferable among the above.

The addition sequence of the raw materials is not limited, but usually, first, (a2) polyol compound and (a3) dihydroxy compound having a carboxy group are provided, and dissolved or dispersed in the solvent, and thereafter, (a1) polyisocyanate compound is added by dropping at 20 to 150° C., and more preferably at 60 to 120° C., which is then reacted at 30 to 160° C., and preferably at 50 to 130° C.

The molar ratio of the added raw materials is adjusted in accordance with the molecular weight and the acid value of the objected polyurethane. In case that (a4) monohydroxy compound is introduced to polyurethane, in order that the polyurethane molecule has an isocyanato group at the end, (a1) polyisocyanate compound must be used in excess of the sum of (a2) polyol compound and (a3) dihydroxy compound having a carboxy group (isocyanato groups in total should be in excess of the hydroxy groups in total). In case that (a5) monoisocyanate compound is introduced to polyurethane, in order that the polyurethane molecule has a hydroxy group at the end, (a1) polyisocyanate compound should be used less than the sum of (a2) polyol compound and (a3) dihydroxy compound having a carboxy group (isocyanato groups in total should be less than hydroxy groups in total).

Specifically, the molar ratio of the provided materials is that isocyanato group of (a1) polyisocyanate compound:(hydroxy group of (a2) polyol compound+hydroxy group of (a3) dihydroxy compound having a carboxy group) is 0.5 to 1.5:1, preferably 0.8 to 1.2:1, and more preferably 0.95 to 1.05:1.

Further, hydroxy group of (a2) polyol compound: hydroxy group of (a3) dihydroxy compound having a carboxy group is 1:0.1 to 30, and preferably 1:0.3 to 10.

When (a4) monohydroxy compound is used, the molar number of (a1) polyisocyanate compound should be in excess of the molar number of ((a2) polyol compound+(a3) dihydroxy compound having a carboxy group), and 0.5 to 1.5 times of molar amount, preferably 0.8 to 1.2 times of molar amount of (a4) monohydroxy compound is used, relative to the excess molar number of the isocyanato group.

When (a5) monoisocyanate compound is used, the molar number of ((a2) polyol compound+(a3) dihydroxy compound having a carboxy group) should be in excess of the molar number of (a1) polyisocyanate compound, and 0.5 to 1.5 times of molar amount, preferably 0.8 to 1.2 times of molar amount of (a5) monoisocyanate compound is used, relative to the excess molar number of the hydroxy group.

In order to introduce (a4) monohydroxy compound to (A) polyurethane containing a carboxy group, when the reaction of (a2) polyol compound and (a3) dihydroxy compound having a carboxy group with (a1) polyisocyanate compound is almost complete, (a4) monohydroxy compound is dropped to the reaction solution at 20 to 150° C., and more preferably at 70 to 120° C., to react the isocyanato groups remaining at both ends of (A) polyurethane containing a carboxy group with (a4) monohydroxy compound, and the temperature is maintained until the end of the reaction.

In order to introduce (a5) monoisocyanate compound to (A) polyurethane containing a carboxy group, when the reaction of (a2) polyol compound and (a3) dihydroxy compound having a carboxy group with (a1) polyisocyanate compound is almost complete, (a5) monoisocyanate compound is dropped to the reaction solution at 20 to 150° C., and more preferably at 50 to 120° C., to react the hydroxy groups remaining at both ends of (A) polyurethane containing a carboxy group with (a5) monoisocyanate compound, and the temperature is maintained until the end of the reaction.

Examples of (B) epoxy compound include: an epoxy compound having two or more epoxy groups in one molecule, such as bisphenol-A type epoxy compound, hydrogenated bisphenol-A type epoxy resin, bisphenol-F type epoxy resin, novolak type epoxy resin, phenol novolak type epoxy resin, cresol novolak type epoxy resin, N-glycidyl type epoxy resin, bisphenol A novolak type epoxy resin, chelate type epoxy resin, glyoxal type epoxy resin, amino group-containing epoxy resin, rubber-modified epoxy resin, dicyclopentadiene phenolic type epoxy resin, silicone-modified epoxy resin, ε-caprolactone-modified epoxy resin, aliphatic-type epoxy resin containing a glycidyl group, alicyclic epoxy resin containing a glycidyl group, etc.

In particular, an epoxy compound having three or more epoxy groups in one molecule is more preferable. Examples of such an epoxy compound include: EHPE (registered trademark) 3150 (manufactured by Daicel Corporation), jER604 (manufactured by Mitsubishi Chemical Corporation), EPICLON EXA-4700 (manufactured by DIC Corporation), EPICLON HP-7200 (manufactured by DIC Corporation), pentaerythritol tetraglycidyl ether, pentaerythritol triglycidyl ether, TEPIC-S (manufactured by Nissan Chemical Corporation), and the like.

The (B) epoxy compound may contain an aromatic ring in a molecule, and in this case, the mass of (B) is preferably 20% by mass or less, relative to the total mass of (A) and (B).

The mixing ratio of (A) polyurethane containing a carboxy group relative to (B) epoxy compound is preferably 0.5 to 1.5, more preferably 0.7 to 1.3, and still more preferably 0.9 to 1.1, in terms of equivalent ratio of the carboxy groups of polyurethane relative to the epoxy groups of (B) epoxy compound.

Examples of (C) curing accelerator include: a phosphine-based compound such as triphenylphosphine, tributylphosphine (manufactured by Hokko Chemical Industry Co., Ltd.), Curezol (registered trademark) (imidazole-based epoxy resin curing agent: manufactured by Shikoku Chemicals Corporation), 2-phenyl-4-methyl-5-hydroxy methyl imidazole, U-CAT (registered trademark) SA series (DBU salt: manufactured by San-Apro Ltd.), Irgacure (registered trademark) 184, and the like. With respect to the used amount of these, if the amount is too small, the effect of addition cannot be obtained, whereas if the amount is too large, the electric insulation is decreased. Therefore, 0.1 to 10% by mass, more preferably 0.5 to 6% by mass, still more preferably 0.5 to 5% by mass, and particularly preferably 0.5 to 3% by mass, is used, relative to the total mass of (A) and (B).

Further, a curing aid may be used together. The curing aid may be a polyfunctional thiol compound, an oxetane compound, and the like. Examples of the polyfunctional thiol compound include: pentaerythritol tetrakis(3-mercaptopropionate), tris-[(3-mercaptopropionyloxy)-ethyl]-isocyanurate, trimethylolpropane tris(3-mercaptopropionate), Karenz (registered trademark) MT series (manufactured by Showa Denko K. K.), and the like. Examples of the oxetane compound include: ARON OXETANE (registered trademark) series (manufactured by Toagosei Co., Ltd.), ETERNACOLL (registered trademark) OXBP or OXMA (manufactured by Ube Industries Ltd.), and the like. With respect to the used amount, if the amount is too small, the effect of addition cannot be obtained, whereas if the amount is too large, the curing rate becomes too high, resulting in decreasing handling property. Therefore, 0.1 to 10% by mass, and preferably 0.5 to 6% by mass is used, relative to the mass of (B).

The content of (D) solvent used in the curable resin composite is preferably 95.0% by mass or more and 99.9% by mass or less, more preferably 96% by mass or more and 99.7% by mass or less, and still more preferably 97% by mass or more and 99.5% by mass or less. (D) solvent can be the solvent used for synthesizing (A) polyurethane containing a carboxy group as it is. Further, other solvent may be used for (D) in order to adjust the solubility of (A) polyurethane or printability. When other solvent is used, the reaction solvent may be distilled away before or after a new solvent is added, to replace the solvent. Taking into account the cumbersomeness of operations and the energy cost, using at least a part of the solvent used for synthesizing (A) polyurethane containing a carboxy group as it is, is preferable. Taking the stability of the composition for the protective layer into account, the contained solvent has a boiling point of preferably 80° C. to 300° C., and more preferably 80° C. to 250° C. If the boiling point is lower than 80° C., the composition is easily dried during the printing, which causes unevenness. If the boiling point is higher than 300° C., heat treatment at a high temperature for a long time is required for drying and curing, which is not suitable for industrial production.

Examples of the (D) solvent include: a solvent used for synthesizing polyurethane such as propylene glycol monomethyl ether acetate (boiling point 146° C.), γ-butyrolactone (boiling point 204° C.), diethylene glycol monoethyl ether acetate (boiling point 218° C.), tripropylene glycol dimethyl ether (boiling point 243° C.), etc., an ether-based solvent such as propylene glycol dimethyl ether (boiling point 97° C.), diethylene glycol dimethyl ether (boiling point 162° C.), etc., a solvent having a hydroxy group such as isopropyl alcohol (boiling point 82° C.), t-butyl alcohol (boiling point 82° C.), 1-hexanol (boiling point 157° C.), propylene glycol monomethyl ether (boiling point 120° C.), diethylene glycol monomethyl ether (boiling point 194° C.), diethylene glycol monoethyl ether (boiling point 196° C.), diethylene glycol monobutyl ether (boiling point 230° C.), triethylene glycol (boiling point 276° C.), ethyl lactate (boiling point 154° C.), etc., methyl ethyl ketone (boiling point 80° C.), and ethyl acetate (boiling point 77° C.). One of these solvents may be used by itself, or a mixture of two or more types of them may be used. When two or more types of solvents are mixed, using a solvent having a hydroxy group and having a boiling point exceeding 100° C. in view of the solubility of the used polyurethane resin, epoxy resin, etc., and in order to prevent aggregation or precipitation, or using a solvent having a boiling point of 100° C. or lower in view of the drying property of the ink, in addition to the solvent used for synthesizing (A) polyurethane containing a carboxy group, is preferable.

The above mentioned curable resin composite can be produced by mixing (A) polyurethane containing a carboxy group, (B) epoxy compound, (C) curing accelerator, and (D) solvent so that the content of (D) solvent becomes 95.0% by mass or more and 99.9% by mass or less, and stirring the mixture until the mixture becomes uniform.

The solid content in the curable resin composite may differ depending on the desired film thickness or printing method, but is preferably 0.1 to 10% by mass, and more preferably 0.5% by mass to 5% by mass. If the solid content is within the range of 0.1 to 10% by mass, when the composition is coated on a transparent conductive layer, problem such that the electrical contact cannot be obtained due to the thick film, do not occur, and a protective layer having a sufficient weather resistance and light resistance can be obtained.

From the viewpoint of light resistance, the ratio of an aromatic ring-containing compound which is defined by the following formula, in the protective layer (the solid content (A) polyurethane containing a carboxy group, (B) epoxy compound, and a cured residue of (C) curing accelerator, in the curable resin composite) is preferably suppressed to 15% by mass or less. Here, “cured residue of (C) curing accelerator” refers to (C) curing accelerator remaining in the protective layer under some curing conditions, while all or a part of the (C) curing accelerator may be disappeared (decomposed, vaporized, etc.) depending on the curing conditions. Further, the “aromatic ring-containing compound” refers to a compound having at least one aromatic ring in a molecule.

Ratio of aromatic ring-containing compound=[(used amount of aromatic ring-containing compound)/(mass of protective layer (mass of (A) polyurethane containing a carboxy group+mass of (B) epoxy compound+cured residue of (C)curing accelerator)]×100(%)

The above mentioned curable resin composite is used in a printing method such as a bar-coat printing, gravure printing, ink-jet printing, slit coating, and the like. The curable resin composite is coated on a substrate having metal nanowire layer formed thereon, the solvent thereof is dried and removed, and thereafter, the curable resin is cured to form a protective layer. The protective layer obtained after the curing has a thickness exceeding 100 nm and 1 μm or less. By forming a protective layer having a thickness of this range on the metal nanowire layer, the transparent conductive film having superior durability of folding can be produced. The protective layer has a thickness of preferably more than 100 nm and 500 nm or less, more preferably more than 100 nm and 200 nm or less, still more preferably more than 100 nm and 150 nm or less, and particularly preferably more than 100 nm and 120 nm or less. If the thickness exceeds 1 μm, obtaining conduction with the wiring, in the subsequent process, becomes difficult.

As mentioned above, the transparent conductive film obtained by sequentially forming a transparent conductive layer (silver nanowire layer) and a protective layer on a transparent substrate has superior durability of folding. Using a clamshell type folding durability tester in which the curvature radius is set to 1 mm, the transparent conductive film is subjected to the folding test of performing 200,000 times of folding. When the resistance value (R₀) represents a resistance value of the transparent conductive film before the folding test, and the resistance value (R) represents a resistance value after the folding test, the ratio (R/R₀) is preferably 2.0 or less, more preferably 1.5 or less, and still more preferably 1.2 or less.

### EXAMPLES

Hereinbelow, specific examples of the present disclosure will be specifically explained. The examples are described below for the purpose of easy understanding of the present disclosure, and the present disclosure is not limited to these examples.

### <Summary of Transparent Conductive Film Evaluation Method>

A silver nanowire ink was produced, which was coated on one of the main faces of the transparent substrate, and dried to form silver nanowire layer. Subsequently, a curable resin composite was produced, which was coated on the silver nanowire layer, and dried to form a protective layer. Thereby, transparent conductive film was produced. The transparent conductive film was subjected to various performance evaluation tests such as a folding test.

### <Preparation of Silver Nanowire>

Polyvinylpyrrolidone K-90 (manufactured by Nippon Shokubai Co., Ltd.) (0.98 g), AgNO₃ (1.04 g), and FeCl₃ (0.8 mg) were dissolved in ethylene glycol (250 ml), and subjected to thermal reaction at 150° C. for one hour. The obtained silver nanowire coarse dispersion liquid was dispersed in 2000 ml of methanol, which was poured into a desktop small tester (using ceramic membrane filter Cefilt, membrane area: 0.24 m², pore size: 2.0 μm, size ϕ: 30 mm×250 mm, filtration differential pressure: 0.01 MPa, manufactured by NGK Insulators, Ltd.), and was subjected to cross-flow filtration at a circulation flow rate of 12 L/min and a dispersion liquid temperature of 25° C., to remove impurities. Thereby, silver nanowires (average diameter: 26 nm, average length: 20 μm) were obtained. The average diameter of the obtained silver nanowires was calculated by using Field Emission Scanning Electron Microscope JSM-7000F (manufactured by JEOL Ltd.). Diameters of arbitrarily selected 100 silver nanowires were measured, and arithmetic average value thereof was calculated. The average length of the obtained silver nanowires was calculated by using 3D Laser Scanning Microscope VK-X200 (manufactured by Keyence Corporation). Lengths of arbitrarily selected 100 silver nanowires were measured, and arithmetic average value thereof was calculated. Regarding the methanol, ethylene glycol, AgNO₃, and FeCl₃, reagents manufactured by FUJIFILM Wako Pure Chemical Corporation were used.

### <Preparation of Conductive Ink (Silver Nanowire Ink)>

11 g of dispersion liquid in which silver nanowires synthesized by the polyol method were dispersed in a mixed solvent of water/methanol/ethanol (silver nanowire concentration 0.62% by mass, water/methanol/ethanol=10:20:70 [mass ratio]), 2.4 g of water, 3.6 g of methanol (manufactured by FUJIFILM Wako Pure Chemical Corporation), 8.3 g of ethanol (manufactured by FUJIFILM Wako Pure Chemical Corporation), 12.8 g of propylene glycol monomethyl ether (PGME, manufactured by FUJIFILM Wako Pure Chemical Corporation), 1.2 g of propylene glycol (PG, manufactured by AGC Inc.), and 0.7 g of PNVA (registered trademark) aqueous solution (manufactured by Showa Denko K.K., solid content concentration 10% by mass, weight average molecular weight 900,000), were mixed and stirred (rotation speed: 100 rpm) by Mix Rotor VMR-5R (manufactured by AS ONE Corporation) for one hour, at a room temperature and under an air atmosphere, and thereby, 40 g silver nanowire ink was produced.

The thermal decomposition starting temperature of PNVA (registered trademark) was measured by TG-DTA2000 manufactured by NETZSCH K. K. Approximately 10 mg of a sample was provided in a platinum pan and was subjected to measurement as below in an air atmosphere, and a thermal decomposition starting temperature was obtained as a temperature which is 120° C. or higher (in order to ignore the influences of the weight reduction which can be found around 100° C. relating to the moisture absorbed in the sample since preliminary drying of the sample was not performed), and at which weight reduction of 1% occurred.

Air Atmosphere, Temperature Conditions: room temperature→(10° C./min)−700° C. (compressor air 100 mL/min)

The thermal decomposition starting temperature of PNVA (registered trademark) used for producing the silver nanowire ink was 270° C.

Table 1 shows concentrations of silver nanowires contained in the obtained silver nanowire ink. The obtained silver concentrations were measured by AA280Z Zeeman atomic absorption spectrophotometer, manufactured by Varian.

### <Preparation of Transparent Conductive Layer (Silver Nanowire Layer)>

A cyclo-olefin polymer film ZF14-013 (glass transition temperature 136° C. [catalog value], thickness 13 μm, manufactured by Zeon Corporation) of A4 size, as a transparent substrate, was subjected to plasma treatment (used gas: nitrogen, feed speed: 50 mm/sec, treatment time: 6 sec, set voltage: 400V) using a plasma processing equipment (AP-T03 manufactured by Sekisui Chemical Co., Ltd.). A silver nanowire ink was coated on the entire surface of the transparent substrate (ZF14-013) to have a wet thickness of 22 μm, by using TQC Automatic Film Applicator Standard (manufactured by Kotec Ltd.) and Wireless Bar Coater OSP—CN-22L (manufactured by Kotec Ltd.) (coating speed 100 mm/sec). Thereafter, the coated film was subjected to hot-air drying at 80° C., for 1 minute, and under an air atmosphere, by using a constant temperature oven HISPEC HS350 (manufactured by Kusumoto Chemicals Ltd.), and thereby a silver nanowire layer was obtained.

### <Measurement of Film Thickness>

Film thickness of the silver nanowire layer was measured using a film thickness measurement system F20-UV (manufactured by Filmetrics Japan, Inc.). Measurement was performed at three different points, and an average value of the measurement results of the three points was used as a film thickness. For analysis, spectrum of 450 nm to 800 nm was used. According to this measurement system, the film thickness (T_{c}) of the silver nanowire layer formed on the transparent substrate can be directly measured. Table 1 shows the measurement results.

### <Preparation of Curable Resin Composite>

### Synthesis Example of (A) Polyurethane Containing Carboxy Group

### Synthesis Example 1: Synthesis of Base Resin Used for Curable Resin Composite Named OC022

42.32 g of C-1015N (polycarbonate diol, molar ratio of raw material diols: 1,9-nonanediol:2-methyl-1,8-octanediol=15:85, molecular weight: 964, manufactured by Kuraray Co., Ltd.) as a polyol compound, 27.32 g of 2,2-dimethylol butanoic acid (manufactured by Nihon Kasei Co., Ltd.) as a dihydroxy compound containing a carboxy group, and 158 g of diethylene glycol monoethyl ether acetate (manufactured by Daicel Corporation) as a solvent were provided in a 2 L three-neck flask having a stirrer, a thermometer, and a condenser, and the 2,2-dimethylol butanoic acid was dissolved at 90° C.

The temperature of the reaction solvent was lowered to 70° C., and 59.69 g of Desmodur (registered trademark)-W (bis(4-isocyanate cyclohexyl)methane), manufactured by Sumika Covestro Urethane Co., Ltd.) as polyisocyanate was dropped thereto for 30 minutes by a dropping funnel. After the dropping was complete, the temperature was raised to 120° C., and the reaction was performed at 120° C. for 6 hours. After the confirmation by IR that almost all of the isocyanate disappeared, 0.5 g of isobutanol was added, which was further reacted at 120° C. for 6 hours. The obtained carboxy group-containing polyurethane had a weight average molecular weight, obtained by GPC, of 32300, and a resin solution thereof had an acid value of 35.8 mgKOH/g.

### Synthesis Comparative Example 1: Synthesis of Base Resin Used for Curable Resin Composite Named PH-50

Except that the polyol compound was changed from 42.32 g of C-1015N to 35.37 g of PH-50 (polycarbonate diol, average molecular weight: approx. 500, manufactured by Ube Industries, Ltd.), and 59.69 g of Desmodur (registered trademark)-W was changed to 66.64 g of Desmodur, the operations same as those of Synthesis Example 1 were performed, to thereby obtain carboxy group-containing polyurethane. The obtained carboxy group-containing polyurethane had a weight average molecular weight of 33100, and a resin solution thereof had an acid value of 35.3 mgKOH/g.

### Curable Resin Composite Example 1 (OC022)

10.0 g of solution of (A) polyurethane containing a carboxy group, obtained by the above Synthesis Example 1 (content of the carboxy group-containing polyurethane: 45% by mass) was weighed in a plastic container, 85.3 g of 1-hexanol and 85.2 g of ethyl acetate were added thereto as (D) solvent, and the resultant was stirred (rotation speed: 100 rpm) by Mix Rotor VMR-5R (manufactured by AS ONE Corporation) for 12 hours, at a room temperature and under an air atmosphere. After visually confirming that the mixture is uniform, 0.63 g of pentaerythritol tetraglycidyl ether (manufactured by Showa Denko K.K.) as (B) epoxy compound, and 0.31 g of U-CAT5003 (manufactured by San-Apro Ltd.) as (C) curing accelerator were added, and stirred by Mix Rotor again for one hour, to thereby obtain Curable Resin Composite Example 1. In the Curable Resin Composite Example 1, the ratio of an aromatic ring-containing compound in the solid content (in the protective layer formed by the Curable Resin Composite Example 1) is 5.7% by mass.

### Curable Resin Composite Comparative Example 1 (PH-50)

10.0 g of solution of (A) polyurethane containing a carboxy group, obtained by the above Synthesis Comparative Example 1 (content of the carboxy group-containing polyurethane: 45% by mass) was weighed in a plastic container, 85.0 g of 1-hexanol and 85.0 g of ethyl acetate were added thereto as (D) solvent, and the resultant was stirred (rotation speed: 100 rpm) by Mix Rotor VMR-5R (manufactured by AS ONE Corporation) for 12 hours, at a room temperature and under an air atmosphere. After visually confirming that the mixture is uniform, 0.62 g of pentaerythritol tetraglycidyl ether (manufactured by Showa Denko K.K.) as (B) epoxy compound, and 0.31 g of U-CAT5003 (manufactured by San-Apro Ltd.) as (C) curing accelerator were added, and stirred by Mix Rotor again for one hour, to thereby obtain Curable Resin Composite Comparative Example 1. In the Curable Resin Composite Comparative Example 1, the ratio of an aromatic ring-containing compound in the solid content (in the protective layer formed by the Curable Resin Composite Comparative Example 1) is 5.7% by mass.

### Preparation of Protective Layer (Production of Transparent Conductive Film) Examples 1 to 3, Comparative Examples 1 and 2

Curable Resin Composite Example 1 and Curable Resin Composite Comparative Example 1 were respectively coated on the silver nanowire layer formed on the transparent substrate, by TQC Automatic Film Applicator Standard (manufactured by Kotec Ltd.) (coating speed 100 mm/sec) as follows. Namely, in Example 1 and Example 2, Wireless Bar Coater OSP—CN-07M was used to have a wet thickness of 7 μm. In Example 3, Wireless Bar Coater OSP—CN-06M was used to have a wet thickness of 6 μm. In Comparative Example 1 and Comparative Example 2, Wireless Bar Coater OSP—CN-05M was used to have a wet thickness of 5 um. The wet thicknesses were adjusted so that the protective layers after the drying have desired values. Thereafter, the coated layer was subjected to hot-air drying (thermal curing) at 80° C., for 1 minute, and under an air atmosphere, by using a constant temperature oven HISPEC HS350 (manufactured by Kusumoto Chemicals Ltd.), and thereby a protective layer was formed, and a transparent conductive film was produced.

### <Measurement of Film Thickness>

Film thickness of the protective layer was measured using a film thickness measurement system F20-UV (manufactured by Filmetrics Japan, Inc.) based on optical interferometry, in the same way as the film thickness measurement of the silver nanowire layer. Measurement was performed at three different points, and an average value of the measurement results of the three points was used as a film thickness. For analysis, spectrum of 450 nm to 800 nm was used. According to this measurement system, the total film thickness (T_{c}+Tₚ) can be directly measured, the film thickness (T_{c}) being a film thickness of the silver nanowire layer formed on the transparent substrate, and the film thickness (Tₚ) being a film thickness of the protective layer formed on the silver nanowire layer. Thus, by subtracting the previously measured film thickness (T_{c}) of the silver nanowire layer from this measurement value, the film thickness (Tₚ) of the protective layer can be obtained. Table 1 shows the measurement results.

### <Folding Test>

For the folding test, a clamshell type folding durability tester (small desktop durability test system Tension-Free (registered trademark) Folding Clamshell-type (manufactured by Yuasa System Co., Ltd.)) capable of performing folding test at 180°, was used. A test piece was produced by cutting the above mentioned A4-sized transparent conductive film into the size of 15 mm×150 mm, and forming terminal parts with silver paste so that the distance between terminals becomes 80 mm. For the silver paste, the conductive paste DW-420L-2A (manufactured by Toyobo Co., Ltd.) was used. The paste was manually coated to be an approximately 2 mm square, which was then subjected to hot-air drying at 80° C., for 30 minutes, and under an air atmosphere, by using a constant temperature oven HISPEC HS350 (manufactured by Kusumoto Chemicals Ltd.), and thereby the terminal parts were formed.

The produced test piece was fixed on the device by adhering with a tape, so that the center of the distance between the terminals was located on the center of the folding line of the device. At the time of the folding test, the curvature radius was 1 mm, folding speed was 30 rpm (performing 30 times of folding-opening operations per minute). The change of resistance values between the terminals before and after the 200,000 times of folding was evaluated. Specifically, a resistance value between the silver paste terminals formed by the above mentioned method was measured by Digital Multimeter PC5000a (manufactured by Sanwa Electric Instrument Co., Ltd.). The resistance value (R₀) before the start of the folding test, and the resistance value (R) after the folding test (200,000 times of folding-opening operations) were measured, respectively, and a ratio (R/R₀) between the resistance value before the start of the folding test and the resistance value after the folding test was calculated and the change was evaluated. In Example 1, Example 3, Comparative Example 1, and Comparative Example 2, the test piece was adhered so that the coated surface facing upward (valley fold), whereas, in Example 2, the test piece was adhered so that the coated surface facing downward (mountain fold). Table 1 shows the evaluation results. When the ratio (R/R₀) of the resistance values is 2.0 or less, evaluation was described as Good. When the ratio (R/R₀) of the resistance values exceeds 2.0, or when the resistance could not be measured due to the generation of cracks, etc., in the transparent conductive film, evaluation was described as Poor. Further, Table 1 also shows results of Reference Example 1 and Reference Example 2 in which folding test of the transparent substrate only was performed. In both Reference Examples, cracks were generated when only the transparent substrate was tested.

### <Measurement of Surface Resistance>

A test piece of 3 cm×3 cm was cut out from the A4-sized COP film with a silver nanowire film coated over the entire surface of the COP film (before the protective layer was formed). The surface resistance was measured by applying a probe of a manual non-contact type resistance measurement instrument EC-80P (manufactured by Napson Corporation). Table 1 shows the measurement results.

### <Total Light Transmittance, Haze Measurement>

Using the above-mentioned 3 cm×3 cm test piece, measurement was performed by Haze meter NDH 2000 (manufactured by Nippon Denshoku Industries Co., Ltd.). Table 1 shows the measurement results.

TABLE 1

| | | | | | | | Comparative | Comparative | Reference | Reference |
|---|---|---|---|---|---|---|---|---|---|---|
| | | | Unit | Example 1 | Example 2 | Example 3 | Example 1 | Example 2 | Example 1 | Example 2 |
| Silver Nanowire Average Diameter | | | nm | 26 | 26 | 26 | 26 | 26 | | |
| Silver Nanowire Average Length | | | mm | 20 | 20 | 20 | 20 | 20 | | |
| Silver Concentration of Ink | | | mass % | 0.17 | 0.17 | 0.17 | 0.17 | 0.17 | | |
| Transparent Substrate (ZF-14) | | | mm | 13 | 13 | 13 | 13 | 13 | 13 | 23 |
| Thickness | | | | | | | | | | |
| Silver Nanowire Layer | | | nm | 80 | 80 | 80 | 80 | 80 | 0 | 0 |
| Thickness T_{c} | | | | | | | | | | |
| Protective Layer | | OC022 | nm | 110 | 110 | 105 | 100 | | 0 | 0 |
| Thickness Tₚ | | PH-50 | nm | | | | | 100 | | |
| Surface Resistance | | | Ω/□ | 43 | 43 | 45 | 55 | 46 | | |
| Total Light Transmittance | | | % | 89 | 89 | 90 | 90 | 90 | | |
| Haze | | | | 0.94 | 0.94 | 0.88 | 0.82 | 0.92 | | |
| Curvature | 1 mm | Number of | Valley | Good | | Good | Poor | Poor | Poor | Poor |
| Radius | | Folding | Fold | (R/R0 = 1.1) | | (R/R0 = 1.1) | (cracked) | (cracked) | (cracked) | (cracked) |
| | | | 200,000 | | | | approx. | approx. | | |
| | | | times | | | | 80,000 | 80,000 | | |
| | | | | | | | times | times | | |
| | | | Mountain | | Good | | | | | |
| | | | Fold | | (R/R0 = 1.1) | | | | | |
| | | | 200,000 | | | | | | | |
| | | | times | | | | | | | |

As shown in Table 1, in Examples 1 to 3 wherein the thickness of the protective layer is thicker than 100 nm, even after the 200,000 times of folding with the curvature radius of 1 mm, the resistance change ratio is within 0.1, which shows preferable durability of folding. On the other hand, in Comparative Example 1 and Comparative Example 2 wherein the thickness of the protective layer is 100 nm or less, when folding is performed with a curvature radius of 1 mm, the film is broken by 80,000 or less times of folding.

Namely, by using a transparent conductive film according to the present disclosure, a transparent conductive film having a superior folding property can be obtained, and this can be preferably applied to a foldable touch panel.

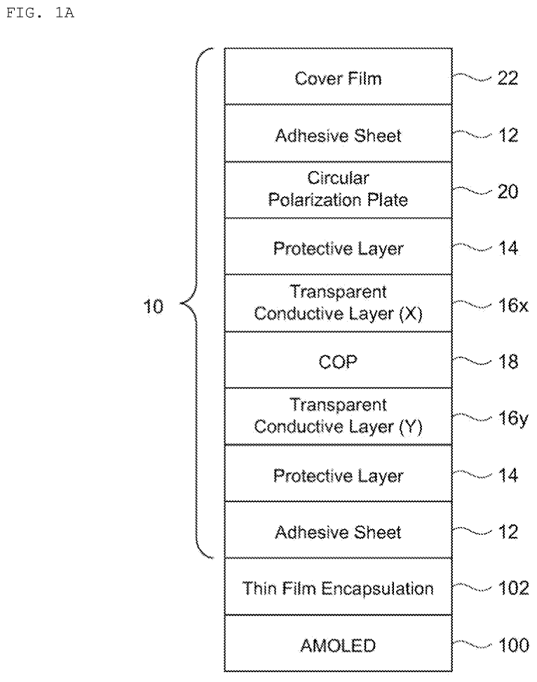

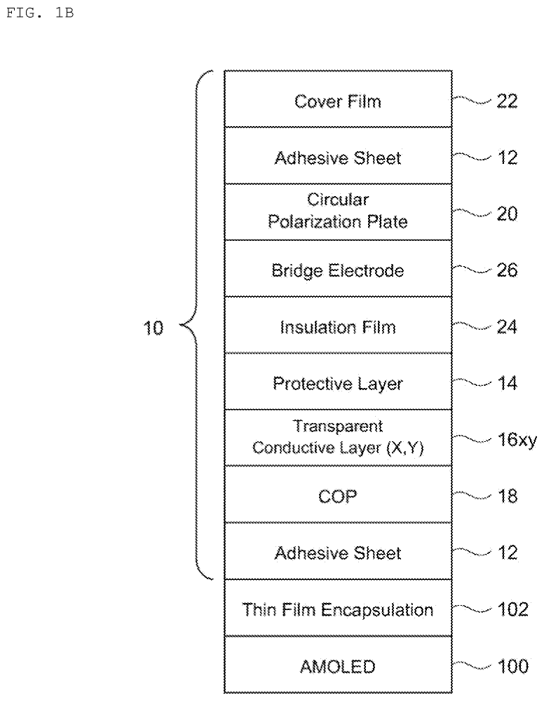

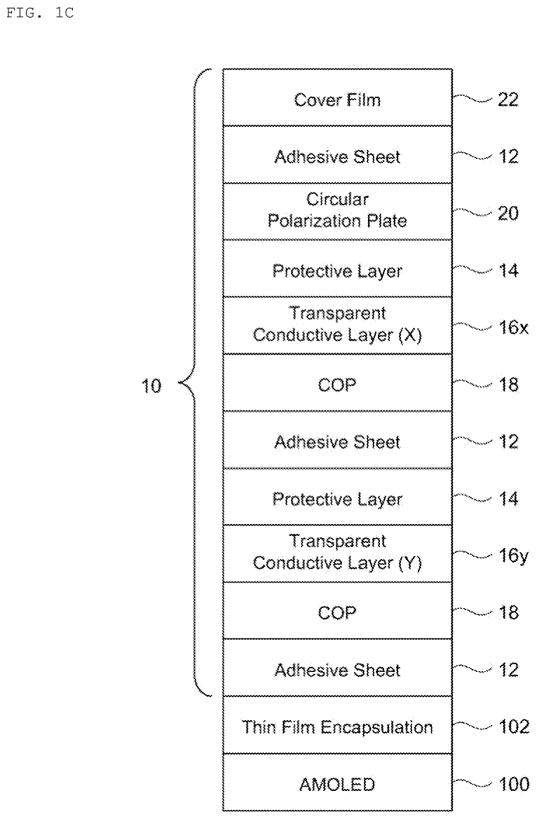

FIG. 1A, FIG. 1B and FIG. 1C show structures of an out-cell type (where, a touch panel is adhered on a display) electrostatic capacitance touch panel according to the present aspect, as a representative example to which the transparent conductive film according to the present disclosure can be applied. Each of FIG. 1A and FIG. 1B shows an electrostatic capacitance touch panel with a structure in which two sensor electrode layers are formed on the film substrate (COP) which is a transparent substrate. FIG. 1C shows an electrostatic capacitance touch panel with a structure in which two films, each having one senor electrode layer formed on a film substrate (COP), are laminated. Here, “AMOLED” shown in FIG. 1A, FIG. 1B, and FIG. 1C represents Active Matrix Organic Light Emitting Diode Display to which the electrostatic capacitance touch panel according to the present aspect can be adhered.

In the example of FIG. 1A, an electrostatic capacitance touch panel 10 is adhered on AMOLED 100 with a thin film encapsulation 102 therebetween. In this case, the electrostatic capacitance touch panel 10 is adhered to the thin film encapsulation 102 by an adhesive sheet (optical adhesive) 12. On the adhesive sheet 12, a protective layer 14, a transparent conductive layer (silver nanowire layer) 16y, a cyclo-olefin polymer (COP) film 18, a transparent conductive layer 16x, a protective layer 14, a circular polarization plate 20, an adhesive sheet 12, and a cover film 22 are stacked in this order, to form a double-sided electrode type electrostatic capacitance touch panel 10 in which transparent conductive layers 16x and 16y are respectively formed on both faces of the cyclo-olefin polymer (COP) film 18. Here, the transparent conductive layer 16x forms a sensor electrode in the x direction, and the transparent conductive layer 16y forms a sensor electrode in the y direction.

In the example of FIG. 1B, the thin film encapsulation 102 and the electrostatic capacitance touch panel 10 are adhered by the adhesive sheet 12. On the adhesive sheet 12, a cyclo-olefin polymer (COP) film 18, a transparent conductive layer 16xy, a protective layer 14, an insulation layer 24, a bridge electrode 26, circular polarization plate 20, an adhesive sheet 12, and a cover film 22 are stacked in this order, to form a bridge-electrode type electrostatic capacitance touch panel 10. Here, the transparent conductive layer 16xy is a transparent conductive layer in which sensor electrode in x direction and a sensor electrode in y direction are formed on the same plane.

In the example of FIG. 1C, the thin film encapsulation 102 and the electrostatic capacitance touch panel 10 is adhered by the adhesive sheet 12. On the adhesive sheet 12, a cyclo-olefin polymer (COP) film 18, a transparent conductive layer 16y, a protective layer 14, an adhesive sheet 12, cyclo-olefin polymer (COP) film 18, a transparent conductive layer 16x, a protective layer 14, a circular polarization plate 20, an adhesive sheet 12, and a cover film 22, are stacked in this order to form an electrostatic capacitance touch panel 10. In the example of FIG. 1C, a cyclo-olefin polymer (COP) film 18, a transparent conductive layer 16y, and a protective layer 14 are stacked in this order to form a laminate; and a cyclo-olefin polymer (COP) film 18, a transparent conductive layer 16x, and a protective layer 14 are stacked in this order to form a laminate; and the transparent conductive layer 16y in the former laminate and the cycloolefin polymer (COP) film 18 in the latter laminate are adhered with an adhesive sheet 12 therebetween. Thereby, a structure consisting of two laminated films can be obtained, each film having a film substrate (cycloolefin polymer (COP) film 18) on which one layer of sensor electrode (transparent conductive layer 16x or 16y) is formed.

In each of FIG. 1A, FIG. 1B, and FIG. 1C, a transparent conductive film according to an aspect is formed by combining a cycloolefin polymer (COP) film 18, a transparent conductive layer 16x, 16y, or 16xy, and a protective layer 14, and each can be produced by a forming method of a silver nanowire layer and a forming method of a protective layer of the above-mentioned aspect.

### EXPLANATION ON NUMERALS

10 electrostatic capacitance touch panel, 12 adhesive sheet, 14 protective layer, 16x, 16y, 16xy transparent conductive layer, 18 cycloolefin polymer (COP) film, 20 circular polarization plate, 22 cover film, 24 insulation film, 26 bridge electrode, 100 AMOLED, 102 thin film encapsulation

1. A transparent conductive film comprising:
a transparent substrate,
a transparent conductive layer having a binder resin and conductive fibers and formed on at least one of the main faces of the transparent substrate, and
a protective layer formed on the transparent conductive layer,
wherein the protective layer is a cured layer of a curable resin composite and has a thickness of more than 100 nm and 1 μm or less.

2. A transparent conductive film according to claim 1, wherein the conductive fiber is a metal nanowire.

3. A transparent conductive film according to claim 2, wherein the metal nanowire is a silver nanowire.

4. A transparent conductive film according to claim 1, wherein the protective layer is a thermally cured layer of a curable resin composite containing (A) polyurethane containing a carboxy group, (B) an epoxy compound, and (C) a curing accelerator.

5. A transparent conductive film according to claim 1, wherein the binder resin is soluble in alcohol, water, or a mixed solvent of alcohol and water.

6. A transparent conductive film according to claim 5, wherein the binder resin contains poly-N-vinylpyrrolidone, water-soluble cellulose-based resin, butyral resin, or poly-N-vinylacetamide.

7. A transparent conductive film according to claim 1, wherein the transparent substrate is a cycloolefin polymer (COP) film.

8. A transparent conductive film according to claim 7, wherein the COP film has a thickness of 5 to 20 μm.

9. A transparent conductive film according to claim 7, wherein the COP film has a glass transition temperature (Tg) is 90 to 170° C.

10. A transparent conductive film according to claim 7, wherein the COP film has a glass transition temperature (Tg) of 125 to 145° C.

11. A transparent conductive film according to claim 1, wherein the protective layer has a thickness of more than 100 nm and 200 nm or less.

12. A transparent conductive film according to claim 1, wherein the protective layer has a thickness of more than 100 nm and 120 nm or less.

13. A transparent conductive film according to claim 1, wherein a content of an aromatic ring-containing compound in the solid of the curable resin composite for forming the protective layer is 15% by mass or less.

14. A transparent conductive film according to claim 1, wherein, when a resistance value (R₀) and a resistance value (R) respectively represents resistance values of the transparent conductive layer before and after 200,000 times of folding tests using a clamshell type durability tester in which the curvature radius is set to 1 mm, the ratio (R/R₀) is 2.0 or less.

15. A touch panel including a transparent conductive film according to claim 1.
